(19) United States
(12) Patent Application Publication
(10) Pub. No.: US 2015/0298200 A1
(43) Pub. Date: Oct. 22, 2015

(54) COATING COMPOUNDS FOR CASTING MOULDS AND CORES THAT PREVENT REACTION GAS DEFECTS

(71) Applicant: ASK Chemicals GmbH, Hilden (DE)

(72) Inventors: Reinhard Stötzel, Solingen (DE); Klemens Eising, Biedenkopf (DE); Karl Smarzoch, Biendenkopf (DE)

(73) Assignee: ASK Chemicals GmbH, Hilden (DE)

(21) Appl. No.: 14/257,372

(22) Filed: Apr. 21, 2014

(51) Int. Cl. B22C 3/00; B22C 9/04; C09D 7/12

(52) U.S. Cl. CPC B22C 3/00; C09D 7/1216; C09D 7/125; B22C 9/04

(57) ABSTRACT

The present invention relates to a coating and a method for producing a casting mold. The method provides for castings whereby gas defects are largely or completely suppressed.

The invention relates to a coating, a method for producing a casting mould, a casting mould such as can be obtained with the method and the use of the casting mould for metal casting.

Most products of the iron and steel industry as well as of the non-ferrous metal industry pass through casting processes for the first shaping. In this case, the molten liquid materials, ferrous metals or non-ferrous metals are converted into geometrically specific objects having specific workpiece properties. In some cases, highly complex casting moulds must initially be produced for the shaping of the castings. The casting moulds are divided into investment casting moulds which are destroyed after each casting as well as permanent moulds which can each be used to produce a large number of castings.

The investment moulds usually consist of a mineral, refractory, granular mould material which is frequently mixed with various further additives, e.g. in order to achieve good casting surfaces. Washed, graded quartz sand is usually used as refractory, granular mould material. For specific applications in which particular requirements must be satisfied, chromite, zirconium and olivine sand are used. In addition, mould materials based on chamotte as well as magnesite, sillimanite or corundum are also used. The binders used to solidify the mould materials can be of an inorganic or organic nature. Smaller investment moulds are predominantly made of mould materials which are solidified by bentonite as binder whereas for larger moulds organic polymers are usually used as binders.

The production of the casting moulds usually proceeds by blending the mould material with the binder so that the grains of the mould material are coated with a thin film of the binder. This mould material mixture is then introduced into a corresponding mould and optionally compacted to achieve a sufficient stability of the casting mould. The casting mould is then cured, for example by heating said mould or by adding a catalyst which brings about a curing reaction. When the casting mould has at least reached a certain initial strength, it can be removed from the mould and transferred to an oven for example, for complete curing in order to be heated to a specific temperature there for a predetermined time.

Permanent moulds are used to produce a plurality of castings. They must therefore withstand the casting process and the associated loadings without being damaged. Depending on the area of application, cast iron as well as unalloyed and alloyed steels, but also copper, aluminium, graphite, sintered metals and ceramic materials have proved particularly suitable as material for permanent moulds. The permanent mould methods include chill casting, pressure casting, centrifugal casting and continuous casting methods.

During the casting process, casting moulds are exposed to very high thermal and mechanical loads. Defects can therefore form at the contact surface between liquid metal and casting mould, for example, by the casting mould tearing or by liquid metal penetrating into the structure of the casting mould. In most cases, therefore, those surfaces of the casting mould which come into contact with liquid metal are provided with a protective coating which is also designated as a coating. Such a coating usually consists of an inorganic refractory material and a binder which are dissolved or suspended in a suitable carrier liquid, for example, water or alcohol.

Due to these coatings, the surface of the casting mould can be modified and adapted to the properties of the metal to be processed. The coating can thus improve the appearance of the casting by producing a smooth surface since the coating compensates for irregularities caused by the size of the grains of the mould material. Furthermore, the coating can metallurgically influence the casting by, for example, additives on the surface of the casting being selectively transferred via the coating into the casting, which additives improve the surface properties of the casting. The coatings furthermore form a layer which chemically isolates the casting mould from the liquid metal during casting. This should prevent adhesion between casting and casting mould so that the casting can be removed from the casting mould without any difficulties. In addition, the coating should ensure thermal separation of casting mould and casting. This is particularly important in permanent moulds. If this function is not satisfied, for example, a metal mould experiences such high thermal loads in the course of successive casting processes that it is prematurely destroyed. However, the coating can also be used to specifically control the heat transfer between liquid metal and casting mould in order, for example, to effect the formation of a specific metal structure by means of the cooling rate.

The coatings usually used contain as base materials, for example, clays, quartz, diatomaceous earth, cristobolite, tridymite, aluminium silicate, zirconium silicate, mica, chamotte or graphite. These base materials cover the surface of the casting mould and close the pores against any penetration of the liquid metal into the casting mould.

On account of their high insulating capacity, coatings containing silicon dioxide or diatomaceous earth as base materials are frequently used since these coatings can be produced at low expense and are available in large quantities.

Important methods for producing metal parts, for example, made of cast iron, are the large casting method and the centrifugal casting method.

In the large casting method used to produce larger castings, investment moulds are usually used. Due to the size of the castings to be produced, very high metallostatic pressures act on the casting mould. Due to the long cooling times, the casting mould is also exposed to a high temperature loading over very long time intervals. In this method, the coating has a defined protective function in order to prevent any penetration of the metal into the material of the casting mould (penetration), tearing of the casting mould (formation of leaf veins) or a reaction between metal and the material of the casting mould (metal penetration).

In centrifugal casting the liquid metal is poured into a tubular or annular ingot mould rotating about its axis, in which the metal is formed into, for example, bushings, rings and tubes under the action of the centrifugal force. In this case, it is absolutely essential that the casting is completely solidified before removing from the casting mould. Consequently, there is a fairly long contact time between casting mould and casting during which the casting mould must not be disadvantageously influenced by the cooling casting. The casting moulds are designed here as permanent moulds, i.e. the casting mould must not change its properties and its shape after the loading by the casting process.

In centrifugal casting, the casting mould is therefore coated with an insulating coating which is applied in a single layer or in the form of a plurality of layers.

DE-B-1 433 973 describes an ingot mould coating in the form of an aqueous suspension which is intended, on the one hand, to avoid damage to ingot moulds during casting and on the other hand is intended to facilitate the shaping of the castings. The coating substantially consists of glassy silicic acid as refractory material as well as colloidal silica sol as binder.

DE-AS-1 303 358 describes a refractory coating which is applied to the walls, the lower part or the base plate of an ingot mould. The coating comprises a chromium-oxide-containing particle-type refractory material as well as an inorganic binder dispersed in a liquid medium. The particle-type refractory material consists of chromite and zirconium oxide, magnesium oxide, titanium oxide or calcined magnesite.

DE 42 03 904 C1 describes a coating for foundry technology purposes containing 5 to 40 wt. % of fibres, 10 to 90% of the fibres consist of an organic material and the remainder of refractory inorganic material. The inorganic fibres have an average length of 50 to 400 μm as well as a diameter of 1 to 25 μm and the organic fibres have an average length of 50 to 5000 μm and a diameter of 2 to 70 μm.

During casting, small funnel-shaped indentations or gas bubbles can form on the outer side of the casting or close below its surface, causing the quality of the surface of the casting to deteriorate and necessitating post-processing of the casting surface.

Particularly in sections in the interior of the castings, for example, oil supply channels in an engine block, such post-processing is difficult or even eliminated. Such sections in the interior of the casting are prepared with so-called cores.

These casting defects can be attributed to various factors.

Depending on the composition of the melt, silicate slag having an almost constant SiO₂ content in the range of about 40% forms on casting ladles. In addition, the slag substantially contains fractions of MnO which fluctuate in the range of 15 to 40% as well as Fe₃O₄ in fractions in the range of 5 to 25 wt. %. This iron oxide-silicate slag forms very rapidly and occurs very frequently accompanied by sulphur in the form of a foamy slag. The slag has an adhesive-like effect and for example, binds loose sand grains which have been released from the mould material of the casting mould. Since the slag can even form at low temperatures, it can not only form during the recovery of the metal in the ladle but also at a later time, for example, when decanting the liquid metal or when pouring the liquid metal into a casting mould. The Fe₃O₄ contained in the slag is substantially responsible for the formation of gas bubbles since it can easily be reduced by CO or H₂, with gaseous reaction products being formed which then lead to the formation of the casting defects described. Various measures can be taken to suppress the formation of gas bubbles. The formation of an Fe₃O₄-containing slag can be counteracted by keeping contact of the melt with oxygen or air as low as possible. To this end, for example, it is possible to strive for the shortest possible casting time. Furthermore, longer standing times of the liquid iron or interruptions of the casting process or multiple recasting of the liquid iron should be avoided.

Furthermore, elements or compounds having an oxygen affinity can be added to the melt, these competing with the iron for the available oxygen and thus suppressing the formation of an Fe₃O₄-containing slag. As a further measure, the manganese content of the melt can be increased to more than 0.5 wt. % so that iron oxide-silicate slags are no longer formed. Finally, the temperature of the melt can be increased to such an extent that the slags are reduced with the formation of carbon monoxide.

At the temperatures prevailing during metal casting, the organic binders in the casting mould decompose to form CO, CO₂, N₂, H₂, NOₓ, NH₃, H₂O and CₓH_{y}. As a result of the reaction of these compounds with liquid iron, further gaseous products are formed which can accumulate in the liquid iron or in the slag. Example reactions are given hereinafter:

Fe+CₓH_{y}→[C]+H₂

Fe₃O₄+CH₄→CO₂+2 CH₂O+3 Fe

2 NH₃→N₂+3 H₂

2 [Al]+3 H₂O→Al₂O₃+3 H₂

Nitrogen and hydrogen are more readily soluble in liquid iron than in solid iron. On transition from the liquid to the solid state, dissolved gases are therefore separated from the melt, which already has a relatively high viscosity in this state. The gas bubbles thus have a shape which less resembles a sphere but is more similar to a blowhole. As a countermeasure, the amount of gas dissolved in the liquid metal can be reduced by lowering the temperature of the melt. Furthermore, the fraction of the binder in the casting mould can be reduced so that smaller quantities of undesirable gases are formed during its decomposition.

Finally, the titanium fraction in the melt can be increased in order, for example, to bind nitrogen in the form of titanium nitride or the aluminium fraction can be reduced in order to repress the formation of hydrogen by reduction of water.

The countermeasures described above are partially contradictory or they can influence the properties of the casting when additives, for example, are added to the melt. Also the casting process possibly cannot be carried out such that contact of the liquid metal with air or oxygen is largely suppressed.

Casting moulds comprise moulds and cores. The moulds form the outer contour of the casting whilst cores are used for forming cavities in the casting. Significantly lower requirements are imposed on the moulds compared with the cores in relation to the stability and the composition of the mould material mixture. Thus, the moulds must withstand significantly lower mechanical loads during casting. Moulds are usually made of wet casting sand. This substantially consists of a refractory material such as quartz sand, bentonite as binder and a lustrous carbon former, for example, coal dust. The wet casting sand also contains water to give the mould material mixture a suitable malleability and mouldability and to solubilize the bentonite as binder. Cores are usually made of a resin-bound mould material mixture. In this case, an organic binder is present as the binder. Example binders are cold-box binders or hot-box binders. As a result of using these binders, the cores acquire a significantly higher stability. Furthermore, the cores must not exhibit too-high evolution of gas during casting. Whereas a very large surface area is available in moulds to remove the gases released during casting to the outside, in cores only the core prints are available which have a relatively small cross-section.

The core prints correspond to the standing areas of the cores on the model. If the gas evolution is too severe, gas can therefore go over into the liquid metal material and lead to casting defects such as pinholes due to the gas bubbles thereby caused.

It was therefore the object of the invention to provide a means whereby gas defects in castings can be largely or completely suppressed and which requires the lowest possible constraints with respect to the composition of the melt or with respect to the metal casting. This means should be capable of being used particularly during the manufacture of cores.

This object is achieved with a coating having the features of patent claim 1. Advantageous further developments of the coating according to the invention are the subject matter of the dependent patent claims.

In addition to a carrier liquid and a pulverulent refractory material, the coating according to the invention contains at least one additive which has reducing properties. The coating forms the contact surface with the liquid metal in the casting mould. The reducing agent acquires a high reactivity due to the heat of the liquid metal so that it can react with oxygen or oxygen-containing compounds and thus trap this. As a result, the formation of Fe₃O₄ is largely suppressed which in turn acts as oxidising agent for carbon or hydrocarbons with the formation of gaseous products. The reducing agent provided in the coating layer can therefore significantly suppress the formation of gases in the interface to the melt and therefore also the formation of pinholes or other gas inclusions at or near the outer surface of the casting.

According to the invention, a coating is therefore provided which can be used as a coating for casting moulds for metal casting, wherein the coating comprises at least:
one carrier liquid;
at least one pulverulent refractory material; and
at least one reducing agent.

The coating initially comprises a carrier liquid in which further components of the coating can be suspended or dissolved. This carrier liquid is suitably selected so that it can be completely evaporated under the conditions usual in metal casting. The carrier liquid should therefore have a boiling point of less than about 130° C., preferably less than 110° C., at normal pressure. Water or an alcohol having 1 to 10 carbon atoms such as, for example, ethanol or isopropanol is preferably used as carrier liquid. Other suitable liquids which can also be present in the carrier liquid in fractions are aliphatic, cycloaliphatic or aromatic hydrocarbons with 3 to 15 carbon atoms, carboxylic acid esters prepared from a carboxylic acid having 2 to 20 carbon atoms and an alcohol component having 1 to 4 carbon atoms, ethers and ketones each having 2 or 3 to 10 carbon atoms.

Preferably a mixture of water and at least one volatile organic component, in particular one or more alcohols, is used as carrier liquid. A volatile organic component is understood in this case as an organic solvent which has a boiling point of less than 130° C., in particular less than 110° C. An alcohol having 1 to 3 carbon atoms, in particular ethanol and/or isopropanol is particularly preferably used as the volatile organic component. The fraction of water in carrier liquid relative to the ready-to-use coating is selected preferably in the range of 10 to 80 wt. %, particularly preferably 10 to 20 wt. % and the fraction of the volatile organic component is preferably in the range of 0 to 70 wt. %, particularly preferably 40 to 60 wt. %.

The fraction of the carrier liquid in the ready-to-use coating is usually 10 to 99.9 wt. %, preferably 30 to 70 wt. %.

At least one pulverulent refractory material is suspended in the carrier liquid. Usual refractory materials in metal casting can be used as refractory material. Examples of suitable refractory materials are diatomite, kaolins, calcinated kaolins, kaolinite, metakaolinite, iron oxide, quartz, aluminium oxide, aluminium silicates such as pyropyllite, kyanite, andalusite or chamotte, zirconium oxide, zirconium silicate, bauxite, olivine, talc, mica, feldspar.

The refractory material is provided in powder form. The grain size is selected so that a stable structure is formed in the coating and that the coating can easily be distributed over the wall of the casting mould, for example, using a spray apparatus. The refractory material suitably has an average grain size of 0.1 to 500 μm, particularly preferably in the range of 1 to 200 μm. Particularly suitable as refractory material are materials which have a melting point at least 200° C. above the temperature of the liquid metal and which do not react with the metal. The fraction of pulverulent refractory material in the ready-to-use coating is preferably selected in the range of 10 to 99.9 wt. %, preferably in the range of 30 to 70 wt. %.

Any element or any compound which can bind oxygen can be used per se as reducing agent. The reducing agent should be capable of being worked well into the coating and is preferably present in solid small-particle form. If the carrier liquid contains water, the reducing agent should not react with the water.

Suitable reducing agents are, for example, silicon metal, silicon organic compounds, aluminium metal or ammonia-releasing means such as ammonium carbonate, urea, melamine or melamine resins.

Carbon-containing compounds are preferably used as reducing agents, those having a very high fraction of carbon being particularly preferred. The carbon-containing compound particularly preferably has a carbon content of more than 70 wt. %, particularly preferably more than 80 wt. %, calculated as C. Carbon monoxide, for example, which can act as a reducing agent is formed from the carbon-containing compound under the heat action of the liquid metal in the presence of oxygen or oxygen-releasing compounds.

In order to achieve the most pronounced possible absorptivity for oxygen, the reducing agent, in particular the carbon-containing compound, should preferably be low in oxygen. The oxygen content of the reducing agent, in particular of the carbon-containing compound, is preferably less than 20 wt. %, particularly preferably less than 10 wt. %, especially preferably less than 5 wt. %, in each case calculated as O₂. Particularly preferably, the reducing agent, in particular the carbon-containing compound contains no oxygen.

The reducing agent can contain nitrogen. It is preferable however that the nitrogen content is not selected to be too high. The nitrogen content of the reducing agent is particularly preferably less than 10 wt. %, especially preferably less than 5 wt. % calculated as N₂.

A lustrous carbon former is particularly preferably used as carbon-containing compound. Lustrous carbon formers are organic compounds or mixtures of organic compounds from which C—H-containing compounds volatilize under the action of the heat of the liquid metal. The gas phase thereby formed is oversaturated with carbon and thus possesses reducing properties. The oversaturation of the gas phase with carbon is ultimately so great that pyrolytic carbon in the form of lustrous carbon is deposited on the surface of the casting mould. The degree of oversaturation of the gas phase with carbon is dependent on the chemical composition of the lustrous carbon former, i.e. the ratio C:H:O, the carbon concentration and on the temperature. The deposition of lustrous carbon on the wall of the mould cavity of the casting mould brings about an inferior wettability of the wall by the melt. The gases formed also influence the impact of the liquid metal on the wall of the casting mould. A so-called “cushioning” of the melt is observed. Due to the deposition of lustrous carbon, the casting can furthermore be removed more easily from the casting mould and the deterioration of the casting mould is advantageously influenced. In addition, the lustrous carbon former becomes plastic under the influence of the heat of the liquid metal and thus, for example, cushions the expansion of the quartz under the action of the heat of the liquid metal.

Preferred lustrous carbon formers have a carbon content of more than 50 wt. %, particularly preferably of more than 70 wt. %, relative to the weight of the dry lustrous carbon former. Suitable lustrous carbon formers are, for example, coal, soot, carbon black, pulverulent bitumen, resin powder such as collophonium or wood resin or also liquid oils.

Suitable lustrous carbon formers for the coating according to the invention preferably have a C/H atomic ratio of more than 0.25, particularly preferably more than 0.5, especially preferably more than 1.

The lustrous carbon formers preferably contain only small quantities of oxygen. The oxygen fraction is preferably less than 20 wt. %, particularly preferably less than 10 wt. %, especially preferably less than 5 wt. %, calculated as O₂ and relative to the dry lustrous carbon former. Lustrous carbon formers containing no oxygen are particularly preferably used.

Suitable lustrous carbon formers can contain nitrogen, for example, in the form of hetero-aromatic groups. However, the nitrogen fraction is preferably selected to be low in order to suppress gas formation by separation of gaseous nitrogen. The lustrous carbon formers preferably contain less than 10 wt. %, particularly preferably less than 5 wt. % nitrogen, calculated as N₂ and relative to the dry lustrous carbon former.

Particularly when very carbon-rich lustrous carbon farmers are used, such as various types of coal, for example, it is preferable if the lustrous carbon former contains the smallest possible fraction of ordered crystalline sections. Thus, for example, graphite which has a high degree of crystal order is barely or not suitable as lustrous carbon former. The lustrous carbon former preferably comprises a crystalline fraction of less than 30%. The crystalline fraction of a lustrous carbon former can, for example, be determined by x-ray diffractometry.

The content of lustrous carbon in a lustrous carbon former can be determined in accordance with the VDG Standard P 83. The lustrous carbon formers preferably used as reducing agents according to the invention preferably have a lustrous carbon content of at least 10 wt. %, in particular of at least 50 wt. %, relative to the weight of the lustrous carbon former.

Preferably coal materials such as bituminous coal, which is particularly preferred, are used as lustrous carbon formers. However, other coal materials such as gas coal or flame coal can also be used.

Furthermore, carbon-containing polymers are preferably used as lustrous carbon formers. Suitable carbon-containing polymers are, for example, phenol resins such as novolac which, however does not give excessively high yields of lustrous carbon on account of its high oxygen fraction. Preferably used as carbon-containing polymers are those polymers having a low oxygen fraction, for example, less than 10 wt. %. Carbon-containing polymers containing no oxygen are particularly preferably used. Particularly preferred in this case are those carbon-containing polymers which have a continuous carbon chain as backbone, i.e. which are obtained for example by radical polymerisation of vinyl monomers. The carbon-containing polymers preferably only contain carbon and hydrogen atoms. Furthermore, the carbon-containing polymers preferably comprise unsaturated and in particular preferably aromatic side groups. As a result, the carbon/hydrogen ratio of the carbon-containing polymer is shifted further in favour of the carbon. Particularly preferably the carbon-containing polymer has a carbon content of more than 90 wt. % and preferably a C/H atomic ratio of 1:2 to 1:1.

A particularly preferred carbon-containing polymer as a lustrous carbon former is selected from the group of polystyrene and copolymers of polystyrene. Example copolymers are styrene butadiene, styrene (meth)acrylate and butadiene (meth)acrylate copolymers. Particularly preferred are copolymers of styrene wherein the fraction of styrene in the carbon-containing polymer is preferably at least 25 mol. %, particularly preferably at least 50 mol. %.

The carbon-containing polymers preferably have an average molecular weight in the range of 2000 to 20,000 g/mol. The molecular weight can be determined, for example, by exclusion chromatography using standards such as polystyrene standards. (e.g. POLYMER STANDARDS SERVICE GmbH, In der Dalheimer Wiese 5, D-55120 Mainz).

The fraction of the reducing agent, preferably of the lustrous carbon former is selected relative to the solid content of the coating according to the invention to be preferably at least 1 wt. %, preferably at least 5 wt. %, particularly preferably at least 6 wt. %, especially preferably in the range of 8 to 30 wt. %. According to one embodiment, the fraction of the lustrous carbon former is selected to be less than 20 wt. %, according to a further embodiment less than 15 wt. %. The quantity of lustrous carbon former contained in the coating is dependent on the quantity of lustrous carbon which can be formed by the lustrous carbon former. Relative to the amount of lustrous carbon formed, the quantity of lustrous carbon former is preferably selected to be at least 1 wt. %, particularly preferably at least 2 wt. % and especially preferably in the range of 2.5 to 10 wt. %.

The lustrous carbon former can be contained in the ready-to-use coating, for example, in a fraction of 1 to 8 wt. %.

The coating according to the invention contains a relatively small fraction of reducing agent or lustrous carbon former. As a result, it can be used as core coating since it only exhibits a small amount of gas evolution. Surprisingly, however, any formation of pinholes can nevertheless be effectively suppressed by the small fraction of lustrous carbon former.

In addition to said components, the coating according to the invention can also comprise further usual components. According to one embodiment of the invention, the coating can contain a binder. The task of the binder is primarily to bind the ingredients of the coating after drying of the coating applied to a casting mould and thus ensure a reliable adhesion of the coating to the subsurface. A binder which cures irreversibly is preferably added. In this way a coating having a high abrasion resistance is obtained. This is advantageous if the casting mould is to be transported, for example, after its completion and is thereby exposed to mechanical influences. Due to the pronounced mechanical robustness of the coating, damage can be largely avoided. Those binders which are not softened again under the action of air humidity are furthermore preferably used.

All binders which have already been used in coatings can be used per se. For example, starch, dextrin, peptides, polyvinyl alcohol, polyvinyl acetate polymers, poly(meth)acrylic acid, polystyrene, polyvinyl acetate-polyacrylate dispersions as well as mixtures of these compounds can be used as binders. According to a preferred embodiment, the coating according to the invention contains an alkyd resin as binder which is soluble both in water and also in alcohols such as ethanol, propanol or isopropanol.

The binder is preferably contained in the ready-to-use coating in a fraction of 0.1 to 5 wt. %, particularly preferably 0.5 to 2 wt. %.

In addition to the aforesaid refractory materials, the coating can also contain a correcting agent. The correcting agent increases the viscosity of the coating. This firstly prevents sinking of the heavier components in the coating so that during application the coating layer always has a uniform composition. Secondly, the correcting agent has the effect that the coating no longer flows after application to the surfaces of the casting mould and therefore a uniform layer thickness is also achieved on, for example, vertical surfaces of the casting mould. Usual two-layer silicates and three-layer silicates in coatings can be used as correcting agents, for example, such as attapulgite, serpentine, smectite, such as saponite, montmorillonite, beidellite and nontronite, vermiculite. Their fraction in the ready-to-use coating is preferably 0.5 to 4.0 wt. %, particularly preferably 1.0 to 2.0 wt. %.

The coating according to the invention can also contain a wetting agent which facilitates the application of the coating to a subsurface. All anionic and non-anionic tensides of medium and high polarity known to the person skilled in the art per se can be used as wetting agents. The tensides preferably have an HLB value of more than 7. The wetting agents are preferably added in a quantity of 0.01 to 1 wt. %, particularly preferably 0.05 to 0.3 wt. %, the percentage information relating to the ready-to-use coating. An example of a suitable wetting agent is disodium dioctylsulpho-succinate.

In order to avoid any foaming during the production of the coating or during application of the coating to the surface of the casting mould, the coating can contain a defoamer.

Foaming during application of the coating can lead to a non-uniform layer thickness and holes in the layer. Silicon or mineral oil, for example, can be used as defoamers. The defoamer is contained in the ready-to-use coating preferably in a fraction of 0.01 to 1 wt. %, particularly preferably 0.05 to 0.3 wt. %.

The coating can further contain usual pigments or dyes. These are optionally added in order, for example, to achieve a contrast between different coating layers or between the casting mould as subsurface and the coating layer located thereon so that a complete application of the coating layer can be checked visually. Examples of suitable pigments are red and yellow iron oxide as well as graphite. The dyes and pigments are preferably contained in the ready-to-use coating in a quantity of 0.01 to 10 wt. %, particularly preferably 0.1 to 5 wt %.

Particularly if the coating is formed as a water coating, that is substantially only water is used as carrier liquid, a biocide can be added to the coating to avoid any bacterial attack and therefore a negative influence on the rheology and the binding force of the binder. Examples of suitable biocides are formaldehyde, 2-methyl-4-isothiazolin-3-one (MIT), 5-chloro-2-methyl-4-isothiazolin-3-one (CIT) and 1,2-benzoisothiazolin-3-one (BIT). Preferably MIT, BIT or a mixture thereof are used. The biocides are preferably used in a quantity of 10 to 1000 ppm, particularly preferably 50 to 500 ppm, relative to the ready-to-use coating.

In the usable state, the coating according to the invention preferably has a solid content in the range of 20 to 80 wt. %, particularly preferably 30 to 70 wt. %. According to one embodiment, the coating has a solid content in the range of 35 to 55 wt. %.

The coating according to the invention can be produced by usual methods. For example, a coating according to the invention can be produced by initially placing water or another suitable carrier liquid in an agitator. Then for example, the correcting agent, for example a phyllosilicate, is added to the water and this is solubilised under highly shearing conditions. The pulverulent refractory material and optionally pigments and dyes and the lustrous carbon former are stirred in until a homogeneous mixture is produced. Finally, wetting agents, anti-foaming agents, biocides and binders are stirred in.

For industrial application, the coating according to the invention can be provided and distributed as a ready-to-use formulation. However, it is also possible to produce and distribute the coating according to the invention in concentrated form. In order to obtain a ready-to-use coating from the concentrated coating, a suitable quantity of a solvent component must be added which is necessary to adjust the required viscosity and density properties of the coating. In addition, the coating according to the invention can also be provided in the form of a kit, wherein, for example, the solid component and the solvent component are provided adjacent to one another in separate containers. The solid component can be provided as a pulverulent solid mixture in a separate container. Further liquid components which are optionally to be used such as, for example, binders, wetting agents, wetters/defoamers, pigments, dyes and biocides can again be provided in a separate container in this kit. The carrier liquid can either be added to the afore-mentioned further liquid components or it can be provided separately from this in a separate container. The suitable quantities of the solid component, the further liquid components and the carrier liquid are blended with one another to produce a ready-to use coating.

It is furthermore also possible to provide a coating according to the invention having a solvent component initially consisting only of water. By adding a volatile alcohol or alcohol mixture, preferably ethanol, propanol, isopropanol and mixtures thereof, preferably in quantities of 40 to 200 wt. % relative to the water coating, a ready-to-use alcohol coating can be prepared from this water coating. The solid content of an alcohol coating according to the invention is preferably 20 to 60 wt. % in this case, particularly preferably 30 to 40 wt. %.

Further characteristic parameters of the coating can be adjusted according to the desired use of the coating according to the invention, e.g. as a base coating or as a top coating, and the desired layer thickness of the coating layer to be applied. Thus, a coating according to the invention which is to be used for coating moulds and cores in foundry technology preferably has a viscosity of 11 to 25 s, particularly preferably 12 to 15 s, determined according to DIN 53211; flow cup 4 mm, DIN cup. A ready-to-use coating preferably has a density in the range of 1 to 2.2 g/ml (0 to 120° Bé), particularly preferably in the range of 1.1 to 1.4 g/ml (30 to 50° Bé), in particular 1.2 to 1.3 g/ml, determined by the Baumé buoyancy method; DIN 12791.

The coating according to the invention can be used for coating casting moulds. The subject matter of the invention is therefore also a method for producing a coated casting mould, whereby a casting mould is provided and the casting mould is coated at least in sections with a coating layer, which comprises at least in parts a layer of a coating as described above.

A casting mould is understood to be all types of bodies required to produce a casting i.e. possibly cores, moulds and ingot moulds. The casting moulds can per se be made of any materials. The casting moulds can, for example, be made of a refractory material such as quartz sand which has been solidified with a suitable binder. Both inorganic and organic binders can be used in this case. An example of an inorganic binder is water glass which has been solidified, for example, by extracting water by heating or by passing through carbon dioxide. Examples of organic binders are cold-box or no-bake binders in which a polyisocyanate component and a polyol component are cured under the action of a basic catalyst.

The coating is particularly preferably used for coating cores. As has already been explained, the coating according to the invention exhibits a comparatively low as evolution. As a result, the risk of gases passing from the core into the liquid metal material during casting is largely suppressed.

Synthetic-resin-bound cores are particularly preferably used as cores.

Preferably cold-box binders are used during the production of such synthetic-resin-bound cores. This comprises a two-component system. The first component consists of a solution of a polyol, usually a phenol resin. The second component is the solution of a polyisocyanate. According to U.S. Pat. No. 3,409,579 A the two components of the polyurethane binder are made to react by passing a gaseous tertiary amine through the mixture of mould base material and binder after the shaping.

A binder system very similar to these cold-box binders are the polyurethane no-bake binders. In this case, a polyisocyanate component is also reacted with a polyol component, the catalyst being added in liquid form, however during the production of the mould material mixture. Amines, for example, tertiary amines are likewise used as catalyst.

The curing reaction of polyurethane binders comprises a polyaddition, i.e. a reaction without separation of side products such as, for example, water. The advantages of the cold box method and the no-bake method include good productivity, dimensional accuracy of the casting moulds and good technical properties such as the strength of the casting moulds, the processing time of the mixture of mould base material and binder, etc.

Further suitable binders are, for example, no-bake binders based on furan resins or phenol resins. They are supplied as two-component systems, where one component comprises a reactive furan resin or phenol resin and the other component comprises an acid which acts as a catalyst for the curing of the reactive resin component. Usually sulphonic acids and in some special cases, phosphoric acid or sulphuric acid are used as acids.

Furan resins contain furfuryl alcohol as an essential component. Furfuryl alcohol can react with itself under acid catalysis and form a polymer. Since furfuryl alcohol is made of vegetable material, for example, wheat chaff or rice husk, it is relatively expensive. Generally therefore, pure furfuryl alcohol is not used to produce furan no-bake binders but further compounds are added to the furfuryl alcohol which are copolymerised into the resin. Examples of such compounds are aldehydes such as formaldehyde or furfural, ketones such as acetone, phenols, urea or also polyols such as sugar alcohols or ethylene glycol.

Further components which influence the properties of the resin can also be added to the resins, for example, their elasticity. Melamine can be added, for example, to bind free formaldehyde.

No-bake binders based on phenol resins contain resols, i.e. phenol resins, as the reactive resin component which have been produced using an excess of formaldehyde. Compared to furan resins, phenol resins exhibit a significantly lower reactivity and require strong sulphonic acids as catalysts.

The hot-curing organic methods include the hot-box method based on phenol or furan resins, the warm-box method based on furan resins and the Croning method based on phenol novolac resins. In the hot-box and warm-box methods liquid resins are processed with a latent curing agent which is only effective at elevated temperatures to give a mould material mixture. In the Croning method mould base materials such as quartz, chrome ore, zirconium sand etc. are clad at a temperature of about 100 to 160° C. with a phenol novolac resin which is liquid at this temperature. Hexamethylene tetramine is added as a reaction partner for the subsequent curing. In the aforesaid hot-curing technologies, the shaping and curing take place in heatable tools which are heated to a temperature of up to 300° C.

Such organic binders are known to the person skilled in the art per se for use in the production of moulds and cores.

In the method according to the invention, a casting mould or a core is initially provided. The coating described above is then applied to this. In this case, all the usual methods per se can be used. The coating can be applied by means of a brush. However it is also possible to spray on the coating by means of a suitable nozzle.

Commercially available pressure vessel spraying devices can be used for the spraying. In this case, the coating is poured into a pressure vessel in a preferably diluted state. The excess pressure prevailing in the vessel presses the coating into a spray gun where it is sprayed with the aid of separately controllable atomizer air. The spraying is preferably carried out in such a manner that the coating impinges still wet upon the surface of the casting mould so that a uniform application can be achieved.

The coating can also be applied by dipping the casting mould into the coating. The time during which the casting mould remains dipped in the coating is preferably selected to be between 2 seconds and 2 minutes. On removing the casting mould, excess coating runs off, the time taken for the excess coating to run off after dipping being determined by the run-off behaviour of the coating used. The coating remaining on the surface of the casting mould then has a specific layer thickness, wherein the layer thickness can be influenced by the properties of the coating, for example, its viscosity or by the addition of correcting agents.

Furthermore, the mould cavity of the casting mould can also be flooded with the coating. When pouring out the coating, a layer of the coating likewise remains on the walls of the mould cavity, wherein the layer thickness of the layer can be influenced, for example, by the viscosity of the coating.

The coating can be applied in a single layer. However, it is also possible to apply a plurality of layers of the coating one above the other in order to achieve, for example, a greater layer thickness. In this case, the lower layer of the coating can optionally first be partially or completely dried before the next layer is applied.

Preferably at least the areas of the casting mould which come in contact with the liquid metal during casting are coated with the coating. The core or cores of the casting mould are particularly preferably coated with the previously described coating.

After application, the coating layer is dried and if the coating contains a curable binder, the binder is cured.

All known methods can be used for drying. The coating can be dried in air, in which case the drying can be promoted, for example, by dehumidifying the air. Furthermore, the casting mould with the coating layer applied thereon can also be heated. For heating, the casting mould can be irradiated, for example, with microwaves or infrared light. However, the coated casting mould can also be placed in a convection oven for drying. According to one preferred embodiment of the method according to the invention, the casting mould coated with the coating is dried in a convection oven at 100 to 250° C., preferably at 120 to 180° C. When using alcohol coatings, the coating is preferably dried by burning off the alcohol or the alcohol mixture. The coated casting mould is additionally heated by the combustion heat thus produced.

The dry layer thickness of the coating layer is preferably at least 0.1 mm, preferably at least 0.2 mm, particularly preferably at least 0.3 mm. Thicker coating layers can also be used for special applications. In such an application, the dry layer thickness is preferably at least 0.4 mm and particularly preferably at least 0.5 mm. Such layer thicknesses are preferably used when the thermal loading of the casting mould is very high.

The thickness of the coating layer particularly preferably lies in the range of 0.3 to 1.5 mm. The dry layer thickness here designates the layer thickness of the dried coating layer which is obtained by substantially complete removal of the carrier liquid and optionally subsequent curing of the coating layer. The dry layer thickness is preferably determined by measuring with a wet layer thickness comb.

Before the coating is applied, the casting mould can also initially be provided with a base coating. The base coating can be applied to the casting mould using all methods known in the prior art, e.g. dipping, flooding, spraying or spreading. The base coating covers the surface of the casting mould and closes the sand pores with respect to any penetration of liquid metal. The base coating also has the task of thermally isolating the casting mould from the liquid metal. As base material, the base coating can contain, for example, clays, talc, quartz, mica, zirconium silicate, magnesite, aluminium silicate or chamotte in a suitable carrier liquid, for example, water or alcohol. The dry layer thickness of the base coating is preferably at least 0.1 mm, particularly preferably at least 0.2 mm, particularly preferably at least 0.45 mm. The dry layer thickness of the base coating is preferably selected in the range of 0.3 to 1.5 mm. The coating for the base coating is preferably formed as a water coating or as an alcohol coating.

The base coating can differ from the coating according to the invention in respect of its composition. However, it is also possible to produce the base coating from the coating according to the invention. The base coating is preferably also produced from the coating according to the invention.

When using a coated casting mould as produced by the method described above, castings are obtained which have few defects attributable to gas inclusions on their surface or near their surface. The subject matter of the invention is therefore also a casting mould which comprises at least sections of a coating layer produced from a coating as described above.

The casting moulds according to the invention are suitable both for centrifugal casting methods and also for large casting methods or generally casting methods based on investment moulds. The subject matter of the invention is therefore also the use of the previously described casting mould for metal casting. Casting moulds having a layer produced from the coating according to the invention are suitable, for example, for producing tubes, cylinder liners, engines and engine components, machine beds and turbines as well as for general machine components. In particular, the casting moulds are suitable for iron and steel casting. During iron or steel casting, relatively high temperatures are achieved in the range of about 1400° C. so that efficient lustrous carbon formation can be initiated.

The invention is explained in detailed by the following examples.

### EXAMPLE 1

The core coatings used in the following examples contain the following components (wt. %):

| Component | Fraction (wt. %) | Manufacturer |
|---|---|---|
| Pyrrophyllite <110 μm | 40.00 | R. T. Vanderbilt |
| Graphite <150 μm | 10.00 | Luh |
| Clay mineral | 03.00 | Engelhard Corporation |
| Butadiene styrene | 05.00 | Lipatone ®, Polymer Latex |
| copolymer dispersion | | |
| Wetting agent | 00.05 | Henkel KGaA, DE |
| Defoamer | 00.20 | Henkel KGaA, DE |
| Binder solution | 02.00 | Wacker AG, DE |
| Biocide | 00.20 | Thor |
| Water | 39.55 | |

In order to produce the coatings, the water was firstly placed in a container fitted with a highly shearing agitator. The agitator is set in operation, the clay is added and solubilized for 15 minutes under highly shearing conditions. Pyrophyllite and graphite are then added and the mixture agitated for a further 15 minutes until a homogeneous mixture is obtained. The remaining components are then added and the mixture agitated for a further 5 minutes.

The coating obtained is diluted with 30 wt. % de-ionized water and then has a viscosity of 13 s determined in accordance with DIN 53211, flow cup 4 mm, and a density of 40° Be. determined by the Baumé buoyancy method, DIN 12791.

A core is then coated with the coating by spraying. The thickness of the coating layer is 300 μm. The coating shows good flow behaviour and good coverage. The casting mould is then dried in a circulating air continuous furnace at 160 to 180° C.

### COMPARATIVE EXAMPLE

A comparative coating was prepared similarly to Example 1 but no butadiene styrene copolymer dispersion was added.

### EXAMPLE 2

Ten each cold box cores (Sand H32, polyurethane cold-box binder (PUCE) Part I 0.8%, PUCB Part II 0.8%) for turbochargers were produced and coated with the coatings prepared in Example 1 and the comparative example. The abrasion resistance of the coating layer was subjectively assessed by abrasion. Casting was the carried out using the SiMo alloy for turbochargers at 1450° C. After removing the casting mould, the surface of the castings was examined for casting defects.

The results are summarised in the following table:

TABLE
Casting experiments

| Coating | Comparative example | Example 1 |
|---|---|---|
| Coating application | 200 μm | 200 μm |
| Abrasion resistance | Good | Very good |
| Castings with pinholes | 5 of 10 | 0 of 10 |

1-19. (canceled)

20. A casting mould which comprises at least sections of a coating layer produced from a coating comprising: a carrier liquid; wherein the carrier liquid is water or an alcohol having 1 to 10 carbon atoms or a mixture of water and at least one volatile organic component having a boiling point of less than 130° C., at least one pulverulent refractory material; and at least one reducing agent, wherein the reducing agent is selected from one or more members of the group consisting of styrene butadiene, styrene (meth)acrylate and butadiene (meth)acrylate copolymers, and wherein the coating has a solid content of 20 to 80 wt. % relative to the usable/ready-to use state and the coating is applied to surfaces of the casting mould which come into contact with liquid metal.

21. The casting mould according to claim 20, wherein the reducing agent is contained in a fraction of more than 5 wt. % relative to the weight of the ready-to-use coating.

22. The casting mould according to claim 20, wherein the coating contains a binder.

23. The casting mould according to claim 20, wherein the casting mould at least comprises a core and the core is coated with said coating.

24. The casting mould according to claim 20, wherein said mould is for metal casting.

25. The casting mould according to claim 24, wherein the metal casting is an iron or steel casting.

26. The casting mould according to claim 20, wherein the reducing agent is a polystyrene polymer or polystyrene co-polymer wherein the fraction of styrene in the polymer is at least about 25 mol %.

27. The casting mould according to claim 20, wherein the reducing agent is a polystyrene polymer or polystyrene co-polymer wherein the fraction of styrene in the polymer is at least about 50 mol %.

28. The casting mould according to claim 26, wherein the reducing agent is a co-polymer selected from one or more members of the group consisting of styrene butadiene, and styrene (meth)acrylate copolymers.

29. The casting mould according to claim 27, wherein the reducing agent is a co-polymer selected from one or more members of the group consisting of styrene butadiene, and styrene (meth)acrylate copolymers.

30. A coating comprising:
a carrier liquid; wherein the carrier liquid is water or an alcohol having 1 to 10 carbon atoms or a mixture of water and at least one volatile organic component having a boiling point of less than 130° C.,
at least one pulverulent refractory material; and
at least one reducing agent, wherein the reducing agent is selected from one or more members of the group consisting of styrene butadiene, styrene (meth)acrylate and butadiene (meth)acrylate copolymers, and wherein the coating has a solid content of 20 to 80 wt. % relative to the usable/ready-to use state, and the coating is applied to surfaces of the casting mould which come into contact with liquid metal.

31. The coating according to claim 30, wherein the reducing agent is contained in a fraction of more than 5 wt. % relative to the weight of the ready-to-use coating.

32. The coating according to claim 30, wherein the coating contains a binder.

33. A method for producing a coated casting mould, wherein a casting mould is provided and the casting mould is coated at least in sections with a coating which comprises at least in parts a coating according to claim 30.

34. The method according to claim 33, wherein the casting mould is initially coated with at least one layer of a base coating and at least one layer of said coating that is applied onto the layer of base coating.

35. The method according to claim 34, wherein the base coating is selected to be different from said coating.

36. The method according to claim 33, wherein the thickness of the coating layer is adjusted between 0.3 and 1.5 mm.

37. The method according to claim 33, wherein the casting mould comprises at least one core and the at least one core is coated with said coating.

38. The coating according to claim 30, wherein the reducing agent is a polystyrene polymer or polystyrene co-polymer wherein the fraction of styrene in the polymer is at least about 25 mol %.

39. The coating according to claim 30, wherein the reducing agent is a polystyrene polymer or polystyrene co-polymer wherein the fraction of styrene in the polymer is at least about 50 mol %.

40. The coating according to claim 30, wherein the reducing agent is a co-polymer selected from one or more members of the group consisting of styrene butadiene, and styrene (meth)acrylate copolymers.

41. A method for producing a coated casting mould, said method comprising the steps of:
i) providing a casting mould; and
ii) coating said casting mould at least in sections with a coating comprising a carrier liquid; wherein the carrier liquid is water or an alcohol having 1 to 10 carbon atoms or a mixture of water and at least one volatile organic component having a boiling point of less than 130° C., at least one pulverulent refractory material; and at least one reducing agent, wherein the reducing agent is selected from one or more members of the group consisting of styrene butadiene, styrene (meth)acrylate and butadiene (meth)acrylate copolymers, and wherein the coating has a solid content of 20 to 80 wt. % relative to the usable/ready-to use state, and the coating is applied to surfaces of the casting mould which come into contact with liquid metal.
